(19) United States
(12) Patent Application Publication
(10) Pub. No.: US 2006/0156342 A1
(43) Pub. Date: Jul. 13, 2006

(54) GENERATING CONSISTENT TIME FOR AN ELECTRONIC PROGRAM GUIDE

(75) Inventor: Wendy Xiao, San Jose, CA (US)

Correspondence Address: DVA/PIONEER RESEARCH CENTER USA, INC.;INTELLECTUAL PROPERTY DEPARTMENT, 2355 MAIN STREET, SUITE 200, IRVINE, CA, 92614, US

(73) Assignee: PIONEER RESEARCH CENTER USA, INC., San Jose, CA (US)

(21) Appl. No.: 10/905,573

(22) Filed: Jan. 11, 2005

(51) Int. Cl. H04N 5/445; G06F 13/00; G06F 3/00

(52) U.S. Cl. 725/50; 725/39; 725/44

(57) ABSTRACT

One embodiment of the invention is a technique to generate consistent timing data for an electronic program guide (EPG). Time information is extracted from a broadcast stream received by a receiver. The time information is based on a first timing reference. The time information is adjusted with respect to a second timing reference used by an electronic program guide (EPG) obtained by the receiver.

### BACKGROUND

1. Field of the Invention

Embodiments of the invention relate to the field of broadcasting, and more specifically, to timing standards.

2. Description of Related Art

Broadcasting technology has become increasingly sophisticated with the advent of high performance video processors and multimedia systems. High Definition Television (HDTV) is the standard for the next generation digital broadcast. Electronic Program Guides (EPGs) have become popular thanks to the proliferation of broadcasting technologies. A wide range of programs can now be broadcast to viewers through cable television, direct satellite systems, or digital networks. With the EPG, viewers can now browse through the scheduled programs, select programs for viewing, scheduling or recording, and perform many complex operations regarding viewing the delivered contents. The merging of HDTV with other video and imaging technologies has created some challenging problems.

In HDTV stream, all time is based on Global Positioning System (GPS) time. GPS is the atomic time scale implemented by the atomic clocks in the GPS group control stations and the GPS satellites. GPS time was zero at 0 hour Jan. 6, 1980, and since it is not perturbed by leap seconds, GPS is now ahead of UTC by 13 seconds. GPS time as an absolute time value, represents the number of seconds since 00:00:00 on Jan. 6, 1980. Accurate time may be transmitted around the globe using satellite navigation technology with, for example, the GPS. This system includes 24 satellites orbiting the Earth where each satellite may have several synchronized atomic clocks. Effectively, this is a highly accurate time-transfer system available to anyone with the technology to use it. Although a signal from one satellite may be enough to determine the time accurately, however, signals of four satellites may be necessary to calculate time and positional information for navigation. It is noted that the clocks that make up the world time system are compared by using GPS satellites as “transfer” standards.

Linux and window operation system is based on Coordinated Universal Time (UTC) and is formerly known as GMT (Greenwich Mean Time). Other terms used to refer to it include “Zulu time”, “universal time,” and “world time”. Local time differs from UTC by the number of hours of the time zone. UTC uses a 24 hours system of time notation. UTC represents hour:minute:second month day, year (i.e., 01:30:00 Jan. 1, 2004). The Linux system provides standard functions call that takes an argument of data type time which represents the number of seconds elapsed since 00:00:00 on Jan. 1, 1970. A structure of time, which includes all information such as local time and day with year, is attainable. UTC is designed to be a compromise between the time defined by atomic clocks, and the time based on the earth's rotation about its axis. The major source of confusion when using UTC is that the date also follows UTC. For example, suppose the local time zone is Central standard, and a shortwave program scheduled to be broadcast at 0400 UTC Saturday. It is calculated that the 0400 UTC is equal to 10:00 p.m. Central standard time. If it is tuned in at 10 p.m. on Saturday, however, the program is not there. Since the date is also UTC, it is necessary to tune in at 10:00 p.m. Friday to receive the program.

Some systems keep a real timer, HDTV stream real time can be used to set this time or it can be set manually. After the conversion of the HDTV stream time to the systems time, all this time can be saved in the systems database with all other EPG data, including a program start time and its duration. All those time converted to systems time. When a user selects one program from an on screen EPG list, the information of the program can be saved in the recording database, sort recording database. The program start time is then compared to the real time. If the start time and the real time match, the program is recorded. It is noted that after all EPG data is saved to the systems database, the system manages and controls the timing issue in one standard time.

One basic problem in digital broadcasting is the difference in timing standards employed by various recoding, imaging, and media streaming systems. Different timing standards lead to program scheduling errors, inconsistencies, and other synchronization problems.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating a computer system in which one embodiment of the invention can be practiced.

FIG. 1B is a diagram illustrating a system in which one embodiment of the invention can be practiced.

FIG. 2 is a diagram illustrating timing relationships according to one embodiment of the invention.

FIG. 3 is a flowchart illustrating a process to generate consistent timing data according to one embodiment of the invention.

FIG. 4 is a flowchart illustrating a process to adjust the timing information according to one embodiment of the invention.

FIG. 5 is a block diagram illustrating a set-top box system in which one embodiment of the invention can be practiced.

FIG. 6 is a flowchart illustrating a process of converting GPS time to system time in which one embodiment of the invention can be practiced.

FIG. 7 is a flowchart illustrating a process of converting EPG data time in which one embodiment of the invention can be practiced.

FIG. 8 is a flowchart illustrating a process of recording program in which one embodiment of the invention can be practiced.

### DESCRIPTION OF THE INVENTION

One embodiment of the invention is a technique to generate consistent timing data for an electronic program guide (EPG). Time information is extracted from a broadcast stream received by a receiver. The time information is based on a first timing reference. The time information is adjusted with respect to a second timing reference used by an electronic program guide (EPG) obtained by the receiver. A video recorder as used herein refers to a device capable of transferring broadcast signals and stored content to an output device, transferring broadcast signals to a storage device, and retrieving the broadcast signals from the storage device. The terms video recorder, personal video recorder (PVR), and digital video recorder (DVR) are used herein interchangeably.

In the following description, numerous specific details are set forth. However, it is understood that embodiments of the invention may be practiced without these specific details. In other instances, well-known circuits, structures, and techniques have not been shown in order not to obscure the understanding of this description.

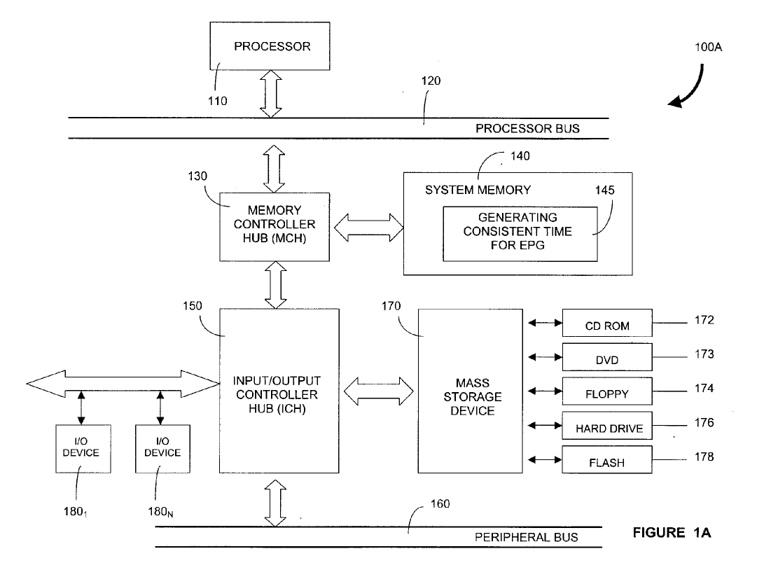

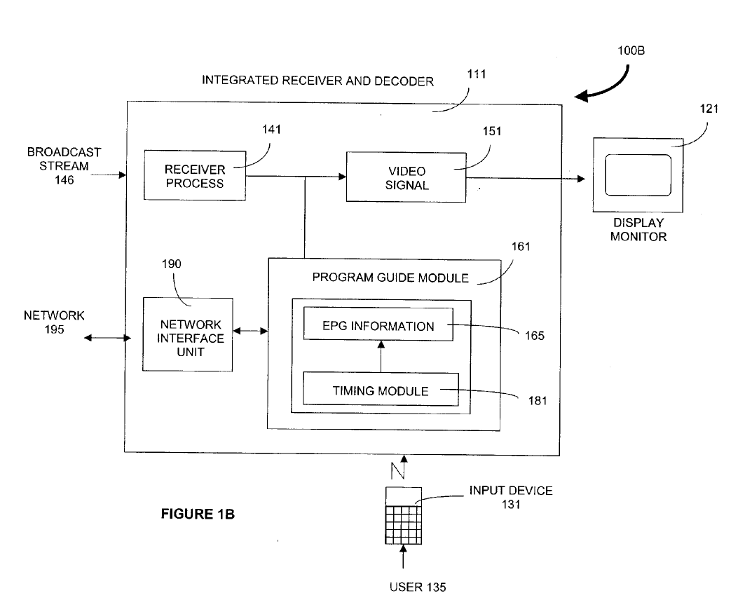

FIG. 1A is a diagram illustrating a processor system 100A in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management 145. Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described in the following. The term “data” here refers to any type of information that is encoded for machine-readable purposes. Therefore, it may include program, code, data, file, etc.

The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, an argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

FIG. 1B is a diagram illustrating a system 100B in which one embodiment of the invention can be practiced. The system 100B includes an integrated receiver and decoder (IRD) 111, a display monitor 121, and an input device 131.

The IRD 111 may be unit separated from the display monitor or a part of a set-top box. It receives a broadcast stream 146 and interacts with a network 195. It includes a receiver processor 141, a video signal processor 151, a program guide processor 161, and a network interface unit 190. The receiver processor 141 performs signal processing to receive the broadcast stream 146. The broadcast stream 146 may be a video signal, a television signal, a radio frequency (RF) signal, a cable signal, or a signal received from a satellite. In one embodiment, the broadcast stream 146 is a high definition (HD) stream. The HD stream containing timing information is based on a first timing reference such as the global positioning system (GPS) timing reference. This timing reference has a starting time as midnight (00:00:00), Jan. 6th, 1980. The receiver processor 141 includes appropriate circuitry to process the broadcast stream 146 such as tuner, intermediate frequency (IF) processor, demodulator, decoder, picture-in-picture processor, etc. The video signal processor 151 performs video signal processing (e.g., luma and chroma processing) to generate video signal to be displayed on the display monitor 121. The video signal processor 151 also interfaces with the program guide processor/module 161 to receive the on-screen display (OSD) information such as the EPG graphical user interface (GUI).

The program guide processor/module 161 processes electronic program guide (EPG) information 165. It includes EPG information 165 and a timing module 181. It contains a processor having memory that contains program code to execute instructions or programs that carry out the operations as described in the following. The program code may be embodied in a machine readable medium such as memory, mass storage device, etc. as described above.

The EPG information 165 includes program identification information such as program title, start time, end time, topic, theme, actors, producers, director, description, and other relevant information for a particular channel. It may be obtained by downloading from a server of an EPG provider. The timing module 181 performs timing adjustment so that the timing data in the EPG information is consistent with the timing information in the broadcast stream. In one embodiment, the scheduled time in the EPG information 165 uses a second timing reference such as the coordinated universal time (UTC). This timing reference may be determined according to the operating system (e.g., Linux, Unix) that runs the timing module 181 as starting from midnight (00:00:00), Jan. 1, 1970. Since the timing references contained in the broadcast stream and in the EPG information 165 or used by the operating system are different, timing inconsistency may arise. This timing inconsistency may lead to incorrect scheduling operations such as recording, displaying, etc.

The display monitor 121 is any display device that displays the received program. It may be a television set, an analog or digital display, a flat panel display, a liquid crystal display, a cathode ray tube (CRT), etc. It may be integrated into a computer system.

The input device 131 allows a user 135 to interact with the recorder 111. It may have a keyboard, an infrared transmitter/receiver, a wireless transmitter/receiver, etc. It may be connected to the IRD 111 or the display monitor 121 in a wired or wireless connectivity. The user 135 uses the input device 131 to view the EPG. The IRD 111 provides graphical user interface (GUI) to allow the user to select programs, channels, program schedules, program contents, etc.

The network interface unit 190 provides interface to the network 195 (e.g., Internet) to allow receiving and/or transmitting network information such as e-mail, account information, subscription information, administrative information, etc.

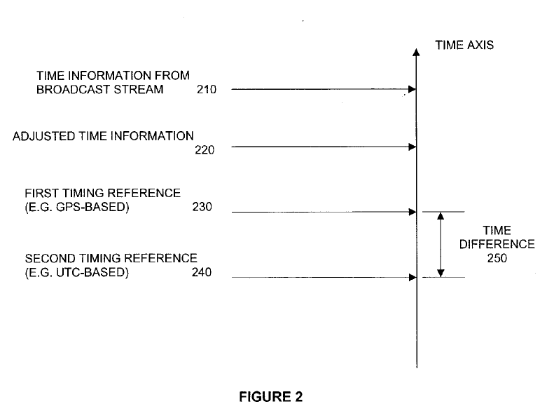

FIG. 2 is a diagram illustrating timing relationships according to one embodiment of the invention. The timing relationships involve time information 210, adjusted time information 220, a first timing reference 230, a second timing reference 240, and a time difference 250.

The timing information 210 is extracted or obtained from the broadcast stream. It is based on the first timing reference 230. The adjusted timing information 220 is the timing information 210 adjusted relative to or with respect to the second timing reference 240. The first timing reference 230 is the reference used by the timing information 210. In one embodiment, the first timing reference 230 is based on the GPS timing reference, which uses a starting time of midnight (00:00:00), Jan. 6th, 1980. The second timing reference 240 is the reference used by the EPG information or the operating system that runs the timing module. In one embodiment, the second timing reference 240 is based on the UTC timing reference, which uses a starting time of midnight (00:00:00), Jan. 1, 1970. The time difference 250 is the difference between the first and second timing references 230 and 240.

For example, from a live stream (i.e., HDTV stream), after parsing the data, the GPS time is received. The GPS time is then converted to the system time (i.e., Pioneer time).

The adjusted timing information 220 (i.e., the total seconds between the GPS time and the UTC time) is computed as follows:

First, a total different number of days are calculated. The total number of days is the number of days plus the number of leap days. For example, the total number of leap days between 1970 and 1980 is calculated as follows:

$$\begin{matrix}Leap days = the integer of ( 1980 \text{-} 1970 ) / 4 \\ = 2\end{matrix} \\ The number of days between January 1 , 1970 and January 6 , 1980 = ( 1980 \text{-} 1970 ) * 365 + 5 days$$

$$The total number of days = the number of days + number of leap days ;$$

Next, the total number of days is to be converted to total number of seconds. It is noted that the GPS is now ahead of UTC by 13 seconds. This is taken into consideration when the conversion occurs.
The UTC/GPS different or UTC/GPS DIFF=total number of days*(24*60*60)+13;
Once the UTC/GPS is determined, the system time is calculated by System time=GPS time+UTC/GPS different.

It is noted that if the current time is on daylight saving time status, one hour is added to the system time to accommodate the correct time.
Therefore, the final system time=system time+(60*60);
In other words, the final system time (T_{adj}) is calculated as follows:
   TD=[(Y1−Y2)*365+(D1−D2)+integer of (Y1−Y2)/4)]*factor. (1)
   T_{adj}=T+TD (2)

Where TD (i.e., UTC/GPS DIFF), Y1, D1, Y2, D2, factor, T_{adj} (i.e., system time), and T (i.e., GPS time) are the time difference 250, the year in the first timing reference, the day in the first timing reference, the year in the second timing reference, the day in the second timing reference, the number of seconds/day, the adjusted timing information, and the timing information, respectively. The factor is a constant equal to (24*60*60+13 seconds)=86,413 seconds/day. Note that this calculation takes into account leap years and that as stated, GPS is now ahead of UTC by 13 seconds).

If the daylight saving is in effect, the adjusted timing information 220 is corrected as follows:
T_{adj}=T_{adj}+3600 (3)
which corresponds to one hour increment.

The timing data from the EPG information can also be corrected to be consistent with the adjusted timing information 220 by taking into account the daylight saving status. If the current time is in daylight saving status, then the time is adjusted as:
T_{EPG}=T_{EPG}+3600 (4)

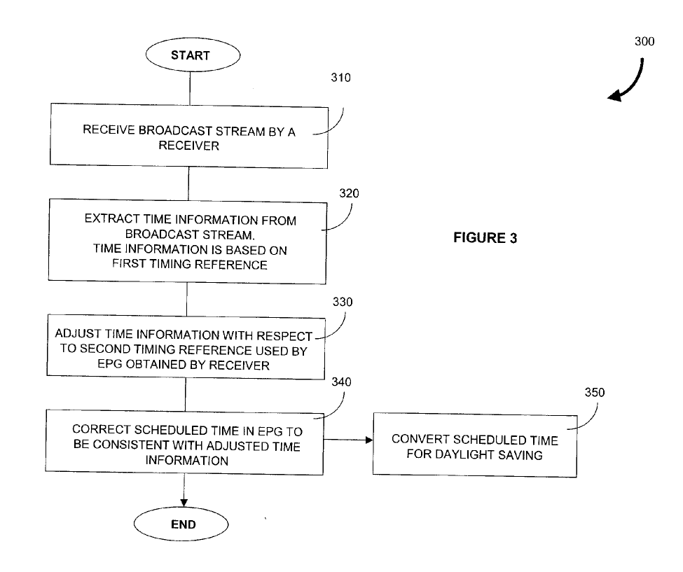

FIG. 3 is a flowchart illustrating a process 300 to generate consistent timing data according to one embodiment of the invention.

Upon START, the process 300 receives a broadcast stream by a receiver (Block 310). Next, the process 300 extracts the time information from the broadcast stream (Block 320). This time information is based on a first timing reference. Then, the process 300 adjusts the time information with respect to a second timing reference used by the EPG information obtained by the receiver (Block 330). Next, the process 300 corrects the scheduled time in the EPG to be consistent with the adjusted time information (Block 340). This may be done by converting the scheduled time for daylight saving (Block 350). The process 300 is then terminated.

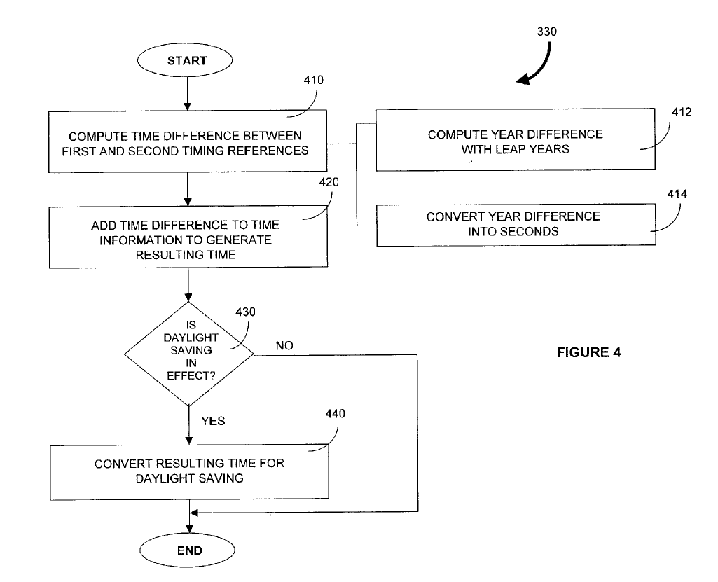

FIG. 4 is a flowchart illustrating a process 330 to adjust the timing information according to one embodiment of the invention.

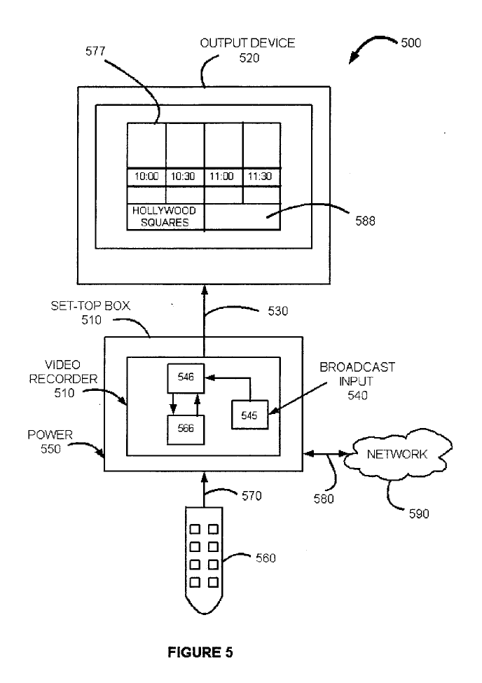

Upon START, the process 330 computes the time difference between the first and second timing references (Block 410). This can be performed by computing a year difference with leap years (Block 412) and converting the year difference into seconds (Block 414). Next, the process 330 adds the time difference to the time information to generate a resulting time (Block 420). Then, the process 330 determines if the daylight saving is in effect (Block 430). If so, the process 330 converts the resulting time for daylight saving (Block 440) and is then terminated. Otherwise, the process 330 is terminated. FIG. 5 is a block diagram illustrating a set-top box system 500 in which one embodiment of the invention can be practiced. The set-top box system includes an output device 520, set-top box 510, a remote control system 560, and a network 590. A video recorder 555 is an internal or external component of a set-top box 510. The video recorder 555 includes some or all of a combination of software, hardware, and firmware as described above. In one embodiment, the video recorder 555 uses a storage device 566, such as a hard drive that is internal or external to the set-top box 510 where shows are saved. The set-top box 510 connects to an output device 520, which facilitates the use of broadcast signals, such as live television signals, video on demand broadcasts, downloads of Internet content, viewing of web pages, and viewing of content previously transferred to the storage device 566. The time reference of the broadcast signals (i.e., HD stream) may be based on GPS seconds. When the EPG data is down loaded from a server, the time reference may be the UTC local time with support daylight saving status. Therefore, to have current correct time, the conversion between the UTC time reference and GPS time reference is necessary. The set-top box 510 is shown as being external to output device 520. It should be understood by someone having ordinary skill in the art, that set-top box 510 might be internal to output device 520 as well.

FIG. 5 is a block diagram illustrating a set-top box system in which one embodiment of the invention can be practiced. A video recorder 555 is an internal or external component of a set-top box 510. The video recorder 555 includes some or all of a combination of software, hardware, and firmware. In one embodiment, the video recorder 555 uses a storage device 566, such as a hard drive that is internal or external to the set-top box 510 where shows are saved. The set-top box 510 connects to an output device 520, which facilitates the use of broadcast signals, such as live television signals, video on demand broadcasts, downloads of Internet content, viewing of web pages, and viewing of content previously transferred to the storage device 566. It should be understood by someone having ordinary skill in the art, that set-top box 510 might be internal to output device 520 as well.

A GUI 577 that includes an IPG 588 is provided, which is displayed on the output device 20. GUI 577 in conjunction with IPG 588 allows the user to control the video recorder 555, typically using a remote control 560. For instance, the user may search the IPG 588 and select shows, which are then scheduled to be transferred to storage device 566. The software or firmware that controls set-top box 510 may be installed locally or it may be downloaded from the Internet as needed when configuring new set-top boxes or when updating existing ones.

Set-top box 510 is connected to output device 520 via a transmission line 530. Broadcast signals are received by the set-top box 510 via broadcast input source 540, which may be connected to either an antenna, cable television outlet, or other suitable input source. One or more tuner systems 545 are configured to allow the system to utilize broadcast signals from multiple channels. The video recorder component 555 includes a hard disk drive 566 in conjunction with a volatile memory 546, such as a Random Access Memory (RAM). Typically, the broadcast input along line 540 is handled by the tuner 545. The signal is temporarily resident in memory 546 using a circular buffer or other cache before being transferred more or less permanently to storage device 566. The tuner system 545 works in conjunction with the storage device 566 so that for each tuner in the system, each can simultaneously transfer broadcast signals to the storage device 566, or display channels up to the given number of tuners on output device 520.

Set-top box 510 receives power through a line 550. Set-top box 510 receives user input entered from a handheld remote control 560 over a wireless link 570. Wireless link 570 may be an infrared (IR) link, a radio frequency (RF) link, or any other suitable type of link. A bi-directional data path 580 is provided to set-top box 510, through which set-top box 510 can access a network 590, either local, global, or both. Transmission line 540 may provide data from a variety of input sources including cable, satellite, or electro-magnetic waves.

In one embodiment of the present invention, the PVR uses multiple tuners. Each of the tuners is normally associated with one encoder and one cache, which may be a fixed or variable size cache (for a live signal) or a fixed file in the case where the incoming signal is merely transferred to the storage device.

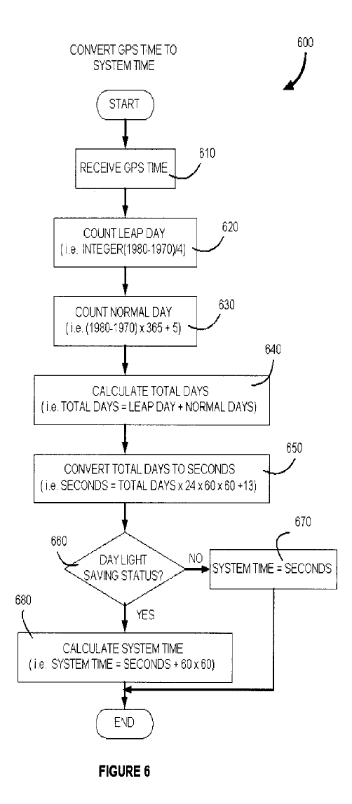

FIG. 6 is a flowchart illustrating a process 600 of converting GPS time to system time in which one embodiment of the invention can be practiced. The process 600 receives GPS time at block 610. It is noted that the HDTV stream is based on the GPS time wherein other systems (i.e., set-top box) may use the operating system time (i.e., Linux operate system). Next, the process 600 counts leap day (i.e., the integer of (1 980−1 970)/4) in (Block 620). The process 600 continues by counting normal days (i.e., the normal days is calculated by (1 980−1 970) multiplying by 365 and adding 5) in (Block 630). The process 600 then continues with the calculation of the total number of days (Block 640). The total number of days is the number of leap days plus the number of normal days. The process 600 then converts the total number days to the number of seconds (i.e., total number of seconds=total days*24*60*60+13, wherein “*” is the multiplication operation and “+” is the addition operation) in block (650). The process 600 then determines whether there is a daylight saving status (Block 660). If no, the system time is equal to the number of seconds (Block 670). Otherwise, the system time is calculated (Block 680). The system time is the number of seconds plus 60*60. The process 600 is terminated.

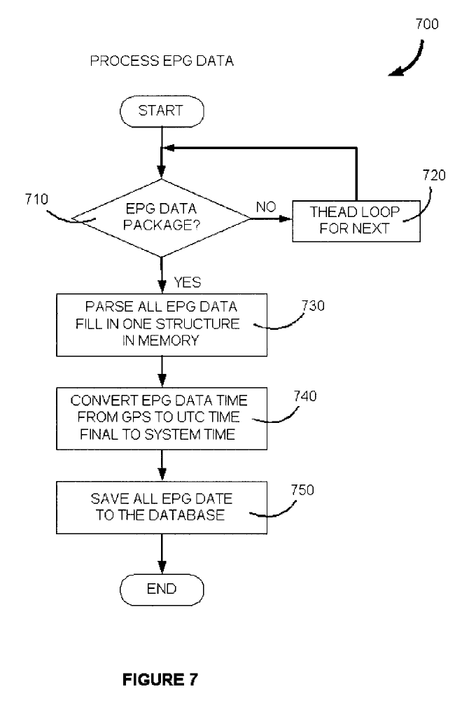

FIG. 7 is a flowchart illustrating a process EPG 700 in which one embodiment of the invention can be practiced. Process 700 determines to see whether there is EPG data package (Block 700). If no, the process starts again after check for the next thread loop (Block 710). The thread loop for next is a while loop in the one thread. If yes, the process 700 continues by parsing all EPG data fill in one structure in memory (Block 720). Next, the process 700 then converts EPG data time from GPS to UTC time (Block 730) since the system time (i.e., set-top box time or system time) is the UTC time (Block 740). The process continues by saving all the EPG data to the database (Block 740). The process 700 is terminated. It is noted that EPG data and system data are included in all data of stream package.

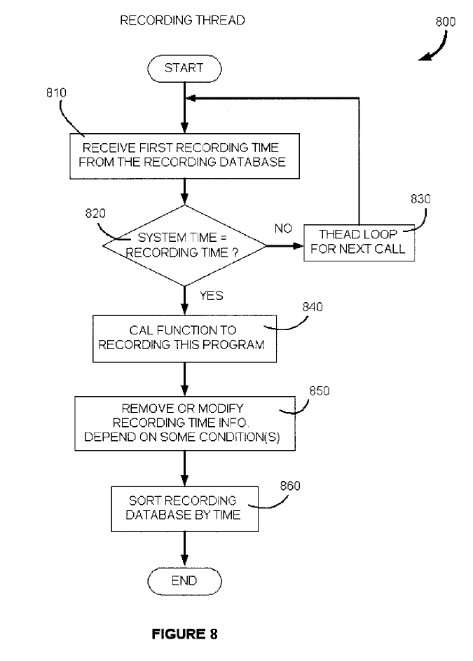

FIG. 8 is a flowchart illustrating a process 800 of recording program (i.e., recording thread) in which one embodiment of the invention can be practiced. The process 800 receives first recording time from the recording database (Block 810). The process 800 then checks whether the system time is the same as the recording time (i.e., system time=recording time) (Block 820). If no, the process 800 starts again after a thread loop for next call (Block 830). If yes, the process 800 continues by calling a function to recording the program (Block 840). Next, the process 800 then removes or modifies recording time information depending on some conditions (Block 850). The process 800 then continues by sorting recording database by time (Block 860). The process 800 is terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
extracting time information from a broadcast stream received by a receiver, the time information being based on a first timing reference; and
adjusting the time information with respect to a second timing reference used by an electronic program guide (EPG) obtained by the receiver.

2. The method of claim 1 further comprising:
correcting scheduled time in the EPG to be consistent with the adjusted time information.

3. The method of claim 1 wherein adjusting comprises:
computing a time difference between the first and second timing references; and
adding the time difference to the time information to generate a resulting time.

4. The method of claim 3 wherein computing the time difference comprises:
computing a year difference taking into account leap years; and
converting the year difference into seconds.

5. The method of claim 3 wherein adjusting further comprises:
converting the resulting time for daylight saving.

6. The method of claim 2 wherein correcting comprises:
converting the scheduled time for daylight saving.

7. The method of claim 1 wherein the broadcast stream is a high definition (HD) stream.

8. The method of claim 1 wherein the first timing reference is based on a global positioning system (GPS) reference.

9. The method of claim 1 wherein the second timing reference is based on a coordinated universal time (UTC).

10. The method of claim 1 wherein the second timing reference is based on a timing reference used by an operating system.

11. The method of claim 2 further comprising recording a program in accordance with the scheduled time.

12. The method of claim 11 wherein the scheduled time is sorted and stored in a database.

13. The method of claim 6 further comprises recording a program in accordance with the scheduled time.

14. The method of claim 13 wherein the scheduled time is sorted and stored in a database.

15. An article of manufacture comprising:
a machine-accessible medium including data that, when accessed by a machine, causes the machine to perform operations comprising:
extracting time information from a broadcast stream received by a receiver, the time information being based on a first timing reference; and
adjusting the time information with respect to a second timing reference used by an electronic program guide (EPG) obtained by the receiver.

16. The article of manufacture of claim 15 wherein the data further comprises data that, when accessed by a machine, causes the machine to perform operations comprising:
correcting scheduled time in the EPG to be consistent with the adjusted time information.

17. The article of manufacture of claim 15 wherein the data causing the machine to perform adjusting comprises data that, when accessed by a machine, causes the machine to perform operations comprising:
computing a time difference between the first and second timing references; and
adding the time difference to the time information to generate a resulting time.

18. The article of manufacture of claim 17 wherein the data causing the machine to perform computing the time difference comprises data that, when accessed by a machine, causes the machine to perform operations comprising:
computing a year difference taking into account leap years; and
converting the year difference into seconds.

19. The article of manufacture of claim 17 wherein the data causing the machine to perform adjusting further comprises data that, when accessed by a machine, causes the machine to perform operations comprising:
converting the resulting time for daylight saving.

20. The article of manufacture of claim 16 wherein the data causing the machine to perform correcting comprises data that, when accessed by a machine, causes the machine to perform operations comprising:
converting the scheduled time for daylight saving.

21. The article of manufacture of claim 15 wherein the broadcast stream is a high definition (HD) stream.

22. The article of manufacture of claim 15 wherein the first timing reference is based on a global positioning system (GPS) reference.

23. The article of manufacture of claim 15 wherein the second timing reference is based on a coordinated universal time (UTC).

24. The article of manufacture of claim 15 wherein the second timing reference is based on a timing reference used by an operating system.

25. A program guide module comprising:
EPG information obtained from an EPG provider; and
a timing module coupled to the EPG information, the timing module comprising:
a module to extract time information from a broadcast stream received by a receiver, the time information being based on a first timing reference, and
a module to adjust the time information with respect to a second timing reference used by an electronic program guide (EPG) obtained by the decoder.

26. The program guide module of claim 25 wherein the timing module further comprises:
a module to correct scheduled time in the EPG to be consistent with the adjusted time information.

27. The program guide module of claim 25 wherein the module to adjust comprises:
a module to compute a time difference between the first and second timing references; and
a module to add the time difference to the time information to generate a resulting time.

28. The program guide module of claim 27 wherein the module to compute the time difference comprises:
a module to compute a year difference taking into account leap years; and
a module to convert the year difference into seconds.

29. The program guide module of claim 27 wherein the module to adjust further comprises:
a module to convert the resulting time for daylight saving.

30. The program guide module of claim 26 wherein the module to correct comprises:
a module to convert the scheduled time for daylight saving.

31. The program guide module of claim 25 wherein the broadcast stream is a high definition (HD) stream.

32. The program guide module of claim 25 wherein the first timing reference is based on a global positioning system (GPS) reference.

33. The program guide module of claim 25 wherein the second timing reference is based on a coordinated universal time (UTC).

34. The program guide module of claim 25 wherein the second timing reference is based on a timing reference used by an operating system.
